(19) United States
(12) Patent Application Publication
(10) Pub. No.: US 2002/0020111 A1
(43) Pub. Date: Feb. 21, 2002

(54) Liquid dispensing devices particularly useful for irrigating plants

(76) Inventor: Peretz Rosenberg, Doar Na Haamakim (IL)

Correspondence Address: c/o ANTHONY CASTORINA, SUITE 207, 2001 JEFFERSON DAVIS HIGHWAY, ARLINGTON, VA, 22202, US

(21) Appl. No.: 09/920,957

(22) Filed: Aug. 3, 2001

(30) Foreign Application Priority Data
Aug. 3, 2000 (IL) 137679

(51) Int. Cl. A01G 25/00; A01G 29/00

(52) U.S. Cl. 47/48.5; 47/79

(57) ABSTRACT

A liquid dispensing device, includes a container for holding a supply of a liquid to be dispensed; a liquid feed tube having one end exposed to the interior of one end of the container for feeding liquid by gravity through the opposite end of the liquid feed tube when the container is inverted with the one end of the container facing downwardly and the opposite end of the liquid feed tube located at a lower elevation than the level of the liquid in the container; an air inlet leading from the atmosphere into the interior of the one end of the container so as to be immersed by the liquid therein when the container is filled with a liquid and inverted; and an air inlet control device effective, when the container is inverted, to block the outflow of liquid from the interior of the container via the air inlet, but to permit atmospheric air to enter, via the air inlet into the interior of the container at a very slow rate and to bubble through the liquid within the container, whereby dispensing of the liquid from the container via the liquid feed tube is also effected at a very slow rate.

### FIELD AND BACKGROUND OF THE INVENTION

The present invention relates to liquid dispensing devices. The invention is particularly useful for irrigating plants, and is therefore described below with respect to such an application, but the invention could also advantageously be used in other applications as will be briefly described below.

A wide variety of devices have been developed for irrigating plants, particularly house plants, in a manner which minimizes the need for personal attention. Some of the known devices are connectable to pressurized water supply pipes for dispensing the water to the plants at periodic intervals, or continuously but at low feed rates. Other known devices are gravity-operated and dispense the water to the plants through drippers or wicks at low rates. However, the latter-type devices, particularly when designed to dispense the water at a very low rate in order to maximize the time before refilling is required, generally exhibit a large tendency to clog, and/or involve a relatively high cost to produce.

### OBJECTS AND BRIEF SUMMARY OF THE INVENTION

An object of the present invention is to provide a novel liquid dispensing device capable of dispensing liquid at a very low rate and having a simple and inexpensive construction capable of being produced at low cost and in volume, such as to make the liquid dispensing device particularly useful for irrigating plants.

According to one aspect of the present invention, there is provided a liquid dispensing device, comprising: a container for holding a supply of a liquid to be dispensed; a liquid feed tube having one end exposed to the interior of one end of the container for feeding liquid by gravity through the opposite end of the liquid feed tube when the container is inverted with the one end of the container facing downwardly and the opposite end of the liquid feed tube located at a lower elevation than the level of the liquid in the container; an air inlet leading from the atmosphere into the interior of the one end of the container so as to be immersed by the liquid therein when the container is filled with a liquid and inverted; and an air inlet control device effective, when the container is inverted, to block the outflow of liquid from the interior of the container via the air inlet, but to permit atmospheric air to enter, via the air inlet into the interior of the container at a very slow rate and to bubble through the liquid within the container, whereby dispensing of the liquid from the container via the liquid feed tube is also effected at a very slow rate.

Preferably, and in acordance with the described preferred embodiments, the opposite end of the liquid tube includes a flow restrictor, such as a commercial water irrigation dripper; also, the ends of the liquid feed tube and of the air inlet tube are both attached to a cap removably closing the mouth of the container.

Several embodiments of the invention are described below for purposes of example.

In one described embodiment, the air inlet control device includes an air inlet tube having one end exposed to the interior of the one end of the container so as to be immersed by the liquid therein when the container is inverted, with the opposite end of the air inlet tube exposed to the atmosphere and retained at a higher elevation than the level of the liquid within the container, such that when the container is inverted, the air inlet tube permits atmospheric air to enter into interior of the container at a very slow rate by bubbling through the liquid within the container, whereby dispensing of the liquid from the container via the liquid feed tube is also effected at a very slow rate.

A second embodiment is described, wherein the air inlet control device includes a flexible membrane on the inner surface of the removable cap, with a portion of the membrane overlying the air inlet, such that when the container is inverted, the membrane at first seals the air inlet by the head of the liquid within the container, but flexes, after a quantity of liquid has been dispensed through the liquid feed tube, to permit atmospheric air to enter into the container and thereby to control the further feeding of liquid from the liquid feed tube.

As will be described more particularly below, such devices are particularly useful for dispensing air irrigation water to a plant, but may also be used in other applications, e.g., for dispensing an infusion liquid to a patient.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates one type of liquid dispensing device constructed in accordance with the present invention for dispensing air irrigation water to a house plant or the like;

FIG. 2 illustrates the dispensing device of FIG. 1 but provided with suspending means for suspending the dispensing device over the plants to be irrigated rather with a ground stake for ground-mounting the device;

FIG. 3 illustrates the device of FIG. 1 but modified to include a plurality of drippers for dispensing the irrigation water at different locations along the liquid feed tube;

FIG. 4 illustrates a device similar to that of FIG. 1 but provided with means to facilitate refilling the container while the container is mounted in its inverted position;

FIG. 5 illustrates another type of liquid dispensing device constructed in accordance with the present invention;

FIG. 6 more particularly illustrates the construction of the cap in the device of FIG. 5 for controlling the inletting of the atmospheric air into the container to control the rate of dispensing the liquid from the container;

FIG. 7 is a top plan view illustrating the cap of FIG. 6;

FIG. 8 illustrates the cap of FIG. 6 in its initial condition when the container is first inverted; and

FIG. 9 illustrates the manner in which the cap allows the controlled entry of ambient air after a quantity of liquid has been dispensed from the inverted container.

### DESCRIPTION OF PREFERRED EMBODIMENTS

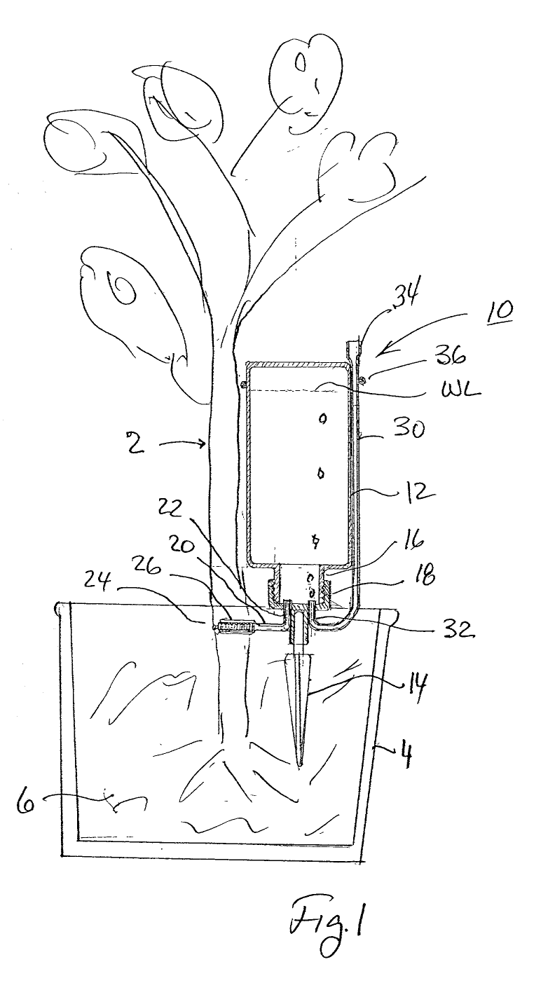

Embodiment of FIGS. 1-4

With reference first to FIG. 1, there is illustrated a house plant 2 growing in a pot or jar 4 filled with dirt or other plant-growing medium 6. FIG. 1 further illustrates a water dispensing device, generally designated 10, for dispensing water to the plant-growing medium 6 at a very slow rate, and over a long period of time, such as many days, weeks or more, to provide the plant with the needed amount of water over this extended period of time.

The water dispensing device 10 includes a container 12 for holding a supply of the water to be dispensed, and a stake 14 for mounting the container in the illustrated inverted vertical position in the plant-growing medium 6. Container 12 may be a plastic container, such as used for bottled water, beverages, or the like, having a neck 16 at one end closed by a threaded cap 18.

According to the present invention, the cap is provided with a water feed tube 20 for feeding the water from the interior of container 12 to the plant-growing medium 6, and an inlet tube 30 for inletting the air into the interior of the container 12 as water is dispensed therefrom in order to equalize the pressure within the container.

As shown in FIG. 1, the water feed tube 20 has one end 22 received within an opening in cap 18 so as to be exposed to, and immersed within, the water in the container 12 when the container is mounted in the illustrated inverted vertical position. The opposite end 24 of the water feed tube 20 is always located at a level below the water level WL within container 12 so as to gravity feed the water from container 12 through the outlet end 24 of the water feed tube 20.

The air inlet tube 30 is operative, as will be described more particularly below, to control the air inletted into the container to a very low rate, and thereby to cause the water to be dispensed via outlet end 24 of the water feed tube 20 at a very low rate. Preferably, the outlet end 24 of the water feed tube 20 further includes a restrictor 26, in the form of a commercially-available water dripper, for further restricting the flow of the water via the outlet end 24 of the water feed tube 20.

The air inlet tube 30 includes one end 32 attached to cap 18 so as to be exposed to, and immersed in, the water within container 12 when the container is in the illustrated inverted vertical position. The opposite end 34 of the air inlet tube 30 is retained, by band 36, at an elevation which is above the water level WL of the water within container 12. Therefore, when the container is in the illustrated inverted vertical position for dispensing water from the water feed tube 20, the air inlet tube 30 permits air to enter the interior of the container, in order to equalize the pressure within the container.

However, as distinguished from conventional techniques, wherein the interior of the container above the water line WL is directly vented to the atmosphere (e.g., by extending end 32 of the water inlet tube 30 above the water line WL within container 12), the inlet end 32 of the tube 30 is at the lower end of the inverted container 12, and is therefore always immersed by the water within the container, so that the air inletted into the container must bubble through the container. This has found to substantially reduce the inflow rate of the air into the container, and thereby the outflow rate of the water from the water feed tube 20.

As one example, container 12 may be a plastic bottle of 0.5 liter or 1.0 liter as used for bottled mineral water, a beverage, or the like; the two tubes 20, 30 may be flexible plastic tubes (e.g., of polyvinyl chloride) having an outer diameter of 4 mm and an inner diameter of 2.5 mm; and the dripper unit 26 may be a commercial in-line dripper of the labyrinth type having a nominal outlet rate of 100-200 cc/hr when used as a conventional dripper. However, when the dripper is used in the device illustrated in FIG. 1, it has been found that the output rate is but a small fraction of the nominal output rate of such a dripper, being a few cc/hr, thereby enabling the device to continuously feed water at an extremely low rate to the plants for several days rather than hours before refilling is required.

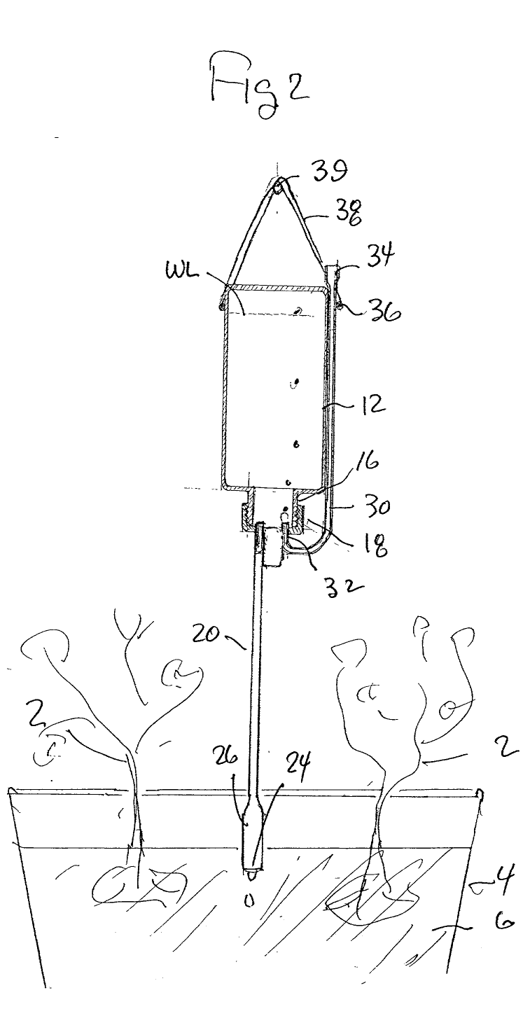

FIG. 2 illustrates a water dispensing device similar to that of FIG. 1, and therefore the corresponding parts are identified by the same reference numerals to facilitate understanding. In FIG. 2, the device 10 includes, instead of a stake 14, a loop 38 for vertically suspending the container 12 in its vertical inverted position also suspending element 39. Loop 38 may be part of band 36 which retains the upper end 34 of the air inlet tube 30 above the water level WL in the container 12.

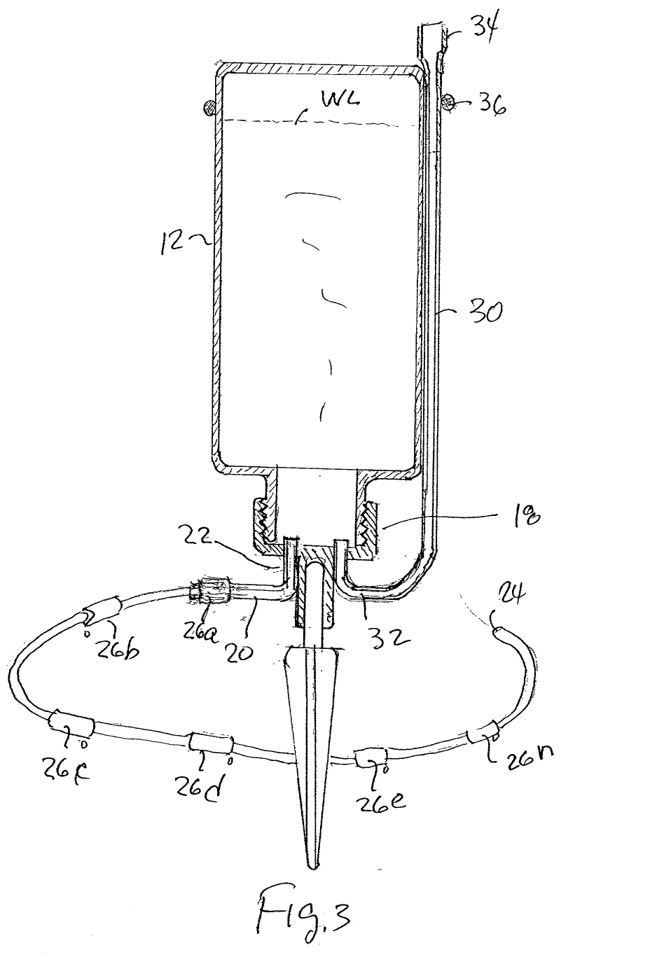

FIG. 3 illustrates the device of FIG. 1 provided with a plurality of dripper units 26a-26n in the water feed line 20 between its end 22 secured to the cap 18, and its opposite end 24. Each dripper unit 26a-26n may be of any commercial construction commonly used in line drippers, and discharges the water at a slow rate at the open end of the respective drip unit. The arrangement illustrated in FIG. 3 may be used, for example, to irrigate a line of plants, or a single large plant, e.g., a tree.

In all the foregoing constructions, the container 12 may be a simple plastic bottle commonly used for bottling water, beverages, and the like.

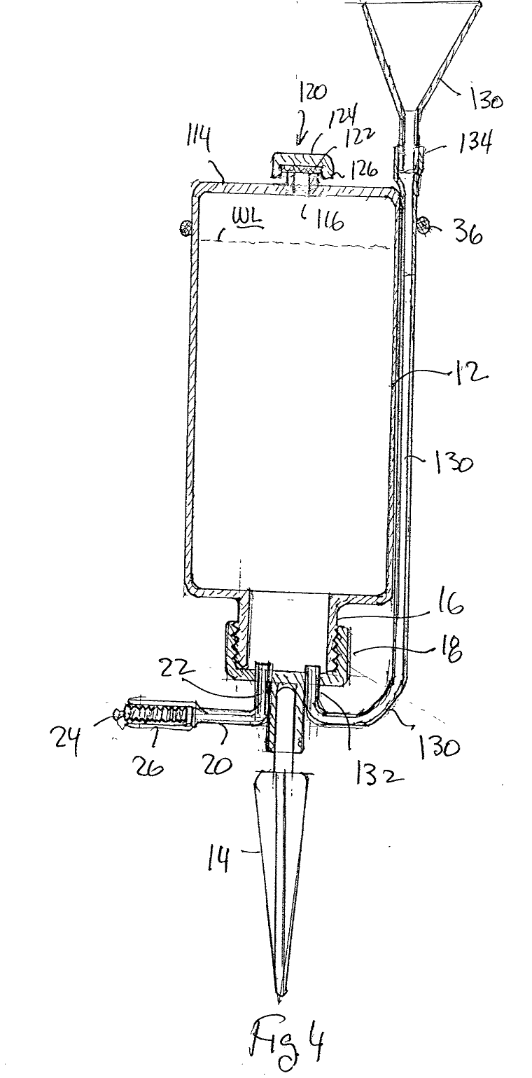

FIG. 4 illustrates another such device but including a container 112 specially constructed to enable it to be refilled with water in a very simple manner without removing it from the plant.

For this purpose, the container wall 114 is provided with an opening 116 which is controlled by a one-way valve, generally designated 120. when container 112 is in the inverted vertical position as illustrated in FIG. 4, valve 120 is effective to permit air to pass therethrough from the interior of the container upwardly to the atmosphere in order to permit refilling the container with water. Valve 120, however, blocks the passage of air through opening 116 from the atmosphere into the interior of the container in order to enable the air inlet tube 30 to control the discharge of the water from the water feed tube 20 in the manner described above.

Thus, one-way valve 120 includes a sealing membrane 122 overlying opening 116 in the container wall 114, and a cap 124 overlying the sealing membrane and lightly pressing it, by the weight of the cap, against the opening 116. Cap 124 is provided with an annular flange 126 circumscribing the sealing membrane 122 so as to retain it within the cap. In all other respects, both the membrane 122 and cap 124 are freely movable away from opening 116 by the pressure within the container 112 and back towards the opening when such pressure is released.

In addition, the end 32 of the air inlet tube 30 exposed to the atmosphere is provided with a funnel 130 to facilitate refilling container 112 with water via the air inlet tube 30.

It will thus be seen that, when container 112 is mounted in the vertical inverted position illustrated in FIG. 4, it may be filled with water via funnel 130 in tube 30, since valve 120 will permit the air within the container to pass through the atmosphere via opening 116 during this filling process. However, at all other times the valve will block opening 116, so that the air can enter into the interior of container 112 only via the air inlet tube 30, thereby permitting that tube to produce a slow discharge of the water via water feed tube 20 as described above.

Embodiment of FIGS. 5-9

FIGS. 5-9 illustrate a second embodiment of the invention which utilizes a flexible membrane for controlling the inletting of air into the container, rather than an air inlet tube retained at a higher elevation than the level of the water within the container as in the embodiment of FIGS. 1-4.

Thus, the water dispensing device, generally designated 200 in FIG. 5, includes a container 212 for holding a supply of the water to be dispensed. Container 212 includes a neck 216 at one end closed by a threaded cap 218 provided with a water feed tube 220 having one end 222 received within an opening in the cap, and the opposite end 224 including a restrictor 226 for restricting the flow via the tube outlet end 224. As in the embodiment of FIGS. 1-4, restrictor 226 may be a commercially-available water dripper of the labyrinth type. It may be inserted to a greater or lesser extent into the end 224 of the water feed tube 220 to at least partially control the dispensing rate from the container.

The cap 218 is also provided with an air inlet 230 for inletting atmospheric air into the interior of the container such that it bubbles through the liquid within the container. In this case, however, the control of the air via the air inlet opening 230 is not by an air inlet tube as in FIGS. 1-5, but rather by a flexible membrane 232 on the inner surface of the cap 218. The arrangement is such that when the container is inverted, the membrane first seals the air inlet by the head of the liquid within the container, but after a quantity of liquid has been dispensed to produce a vacuum within the container, membrane 232 flexes to permit atmospheric air to enter into the container.

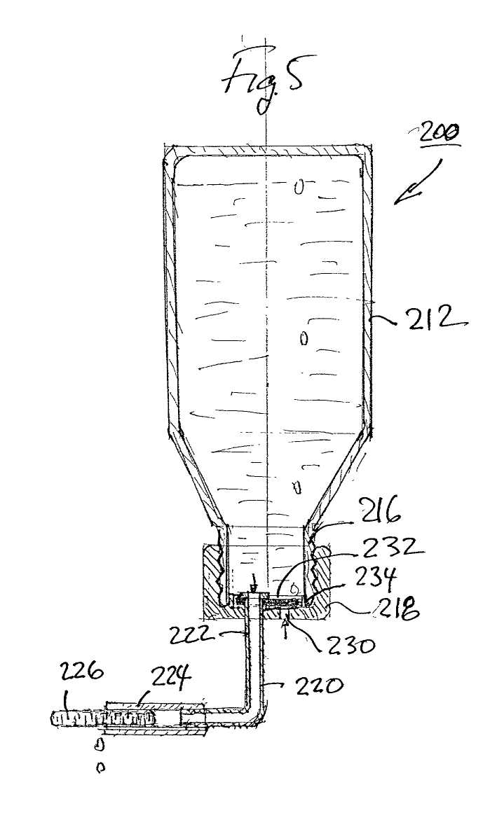

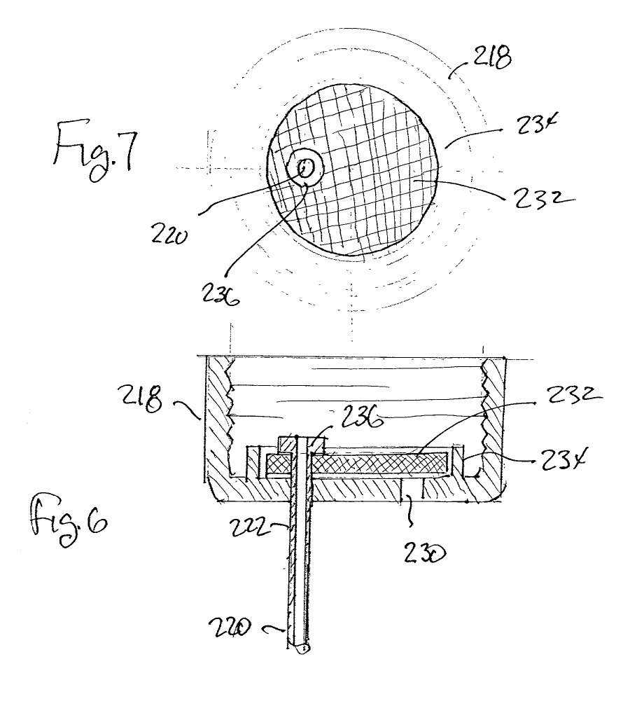

As more particularly seen in FIGS. 6 and 7, such a membrane 232 is of circular configuration and is enclosed by an annular rib 234 formed in the inner surface of the cap 218. The water feed tube 220 passes through one side of the membrane 232 and is formed with an enlarged head 236 to secure that side of the membrane to the cap, with the opposite side of the membrane overlying the air inlet opening 230.

Preferably, membrane 232 is made of a natural or synthetic elastomeric material.

The device illustrated in FIGS. 5-9 operates as follows:

When the cap 218 is removed, the container 212 may be filled with the liquid to be dispensed, e.g., water for irrigating plants. The cap 218 is then applied, and the container 212 is inverted to the position in FIG. 5.

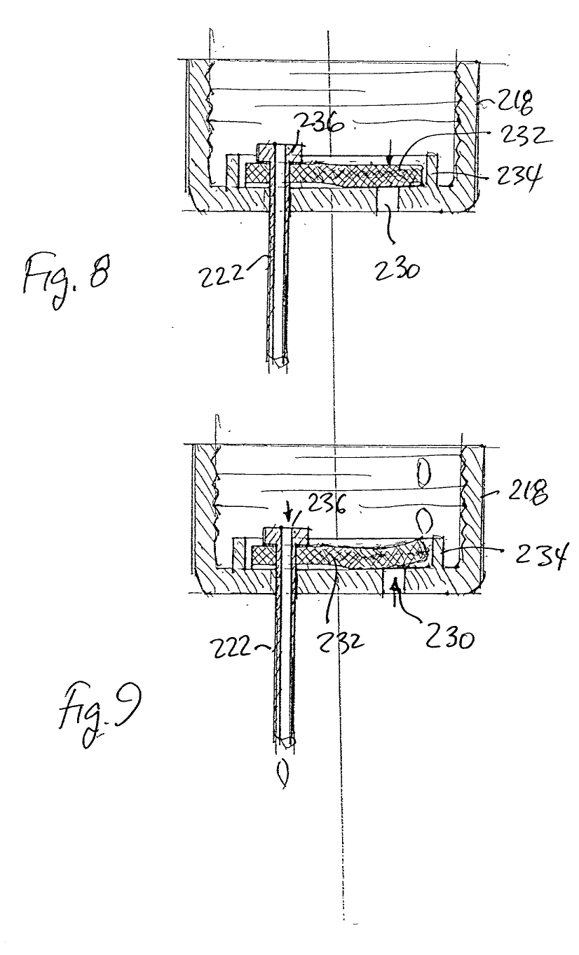

Initially, the pressure head of the liquid within the container presses the flexible membrane 232 against the inner face of the cap 218, to close the air inlet opening 230, as shown in FIG. 8. However, the pressure head also forces some liquid through the feed tube 220 and out through its end 224, as controlled by the restrictor 226, shown in FIG. 5. This creates a slight vacuum in the upper end of the container 212. This vacuum flexes the end of the membrane 232 covering the air inlet 230 sufficient to allow some air to enter, as shown in FIG. 9. This air bubbles through the liquid, as shown in FIG. 5, to reduce the vacuum at the upper end of the container 212, which causes the membrane 232 to reclose the air inlet 230. A steady-state condition is eventually reached wherein the membrane controls the feeding rate of the liquid through the feed tube 220 by controlling the air permitted to enter the air inlet 230.

It will be appreciated that the device illustrated in FIGS. 5-9 can also be mounted by means of a stake as shown in FIG. 1, or by means of a suspension loop, as shown in FIG. 2.

While the invention has been described with respect to several preferred embodiments, it will be appreciated that these are set forth merely for purposes of example, and that many variations and other applications may be made. An example of another application of the invention is for controlling the dispensing of an infusion liquid to a patient. Many other variations and applications of the invention will be apparent.

What is claimed is:

1. A liquid dispensing device, comprising:
a container for holding a supply of a liquid to be dispensed;
a liquid feed tube having one end exposed to the interior of one end of the container for feeding liquid by gravity through the opposite end of the liquid feed tube when the container is inverted with said one end of the container facing downwardly and said opposite end of the liquid feed tube located at a lower elevation than the level of the liquid in the container;
an air inlet leading from the atmosphere into the interior of said one end of the container so as to be immersed by the liquid therein when the container is filled with a liquid and inverted; and
an air inlet control device effective, when the container is inverted, to block the outflow of liquid from the interior of the container via said air inlet, but to permit atmospheric air to enter, via said air inlet into the interior of the container at a very slow rate and to bubble through the liquid within the container, whereby dispensing of the liquid from the container via the liquid feed tube is also effected at a very slow rate.

2. The device according to claim 1, wherein said opposite end of the liquid feed tube includes a flow restrictor.

3. The device according to claim 1, wherein said container has a mouth closed by a removable cap; and wherein said one end of the liquid feed tube and said air inlet are both in said cap.

4. The device according to claim 3, wherein said cap further includes a ground stake for mounting said container in said inverted position over the ground.

5. The device according to claim 1, wherein said air inlet control device includes an air inlet tube having one end exposed to the interior of said one end of the container so as to be immersed by the liquid therein when the container is inverted, with the opposite end of the air inlet tube exposed to the atmosphere and retained at a higher elevation than the level of the liquid within the container, such that when the container is inverted, the air inlet tube permits atmospheric air to enter into interior of the container at a very slow rate by bubbling through the liquid within the container, whereby dispensing of the liquid from the container via the liquid feed tube is also effected at a very slow rate.

6. The device according to claim 5, wherein said opposite end of the air inlet tube is held above the liquid level in the container by a retainer band enclosing both said opposite end and said container.

7. The device according to claim 6, wherein said retainer band further includes a loop for vertically suspending said container in inverted position.

8. The device according to claim 5, wherein said opposite end of the air inlet tube is of a funnel configuration to permit refilling said container with liquid.

9. The device according to claim 1, wherein said opposite end of the container is provided with a venting opening closable by a one-way valve which permits passage of air therethrough from the interior of the container to the atmosphere when refilling the container with liquid while the container is in said inverted position, but blocks the passage therethrough of air from the atmosphere into the container while the container is in said inverted position for dispensing liquid therefrom.

10. The device according to claim 9, wherein said one-way valve includes a sealing membrane overlying said venting opening, and a cap overlying said sealing membrane and lightly pressing it against the venting opening, but movable therewith to permit venting the container interior to the atmosphere when refilling the container with liquid.

11. The device according to claim 1, wherein said air inlet control device includes a flexible membrane on the inner surface of said removable cap, with a portion of the membrane overlying said air inlet, such that when the container is inverted, said membrane at first seals said air inlet by the head of the liquid within the container, but flexes, after a quantity of liquid has been dispensed through the liquid feed tube, to permit atmospheric air to enter into the container and thereby to control the further feeding of liquid from the liquid feed tube.

12. The device according to claim 11, wherein said flexible membrane is secured to the inner surface of said removable cap by said liquid feed tube.

13. The device according to claim 11, wherein said flexible membrane is of elastomeric material.

14. The device according to claim 11, wherein said membrane is circumscribed by a rib integrally formed on the inner surface of the cap.

15. The device according to claim 11, wherein said flexible membrane and said rib are of circular configuration.

16. The device according to claim 1, wherein said container is constructed to hold a supply of irrigating water for irrigating plants.

17. The device according to claim 1, wherein said container is constructed to hold a supply of an infusion liquid to be dispensed to a patient.
